(19) United States
(12) Patent Application Publication
(10) Pub. No.: US 2022/0100328 A1
(43) Pub. Date: Mar. 31, 2022

(54) MANAGING NAVIGATION OF MULTIPLE CONTENT FLOWS IN AN ELECTRONIC PUBLICATION

(71) Applicant: Amazon Technologies, Inc., Seattle, WA (US)

(72) Inventors: Hemant Kumar Agrawal, Seattle, WA (US); Gajendran Mani, Chennai (IN); V Radhakishan, Chennai (IN); Abdul Majeeth, Chennai (IN); Inbarasan Thangamani, Piranmalai (IN); Niveda Harishankar, Seattle, WA (US); Prasanna Somasundaram, Seattle, WA (US); David Lane, Seattle, WA (US); Lokesh Joshi, Bellevue, WA (US)

(21) Appl. No.: 17/039,113

(22) Filed: Sep. 30, 2020

(51) Int. Cl. G06F 3/0482; G06F 3/0484; G06F 16/93

(52) U.S. Cl. CPC G06F 3/0482; G06F 16/93; G06F 3/0484

(57) ABSTRACT

A method and system to maintain, in a data store associated with a device, first content of an electronic publication, second content of the electronic publication, and mapping information enabling navigation between a first navigational structure of the first content and a second navigational structure of the second content. In response to one or more first indications, the first navigational structure of the first content is navigated. The method and system receive, via an access point corresponding to a first location of the first navigational structure, an indication to access the second navigational structure. Using the mapping information, a second location within the second navigational structure is determined in view of the first location of the first navigational structure. The method and system generate, via an interface of the device, a display comprising a portion of the second content corresponding to the second location within the second navigational structure.

### BACKGROUND

A large and growing population of users enjoy reading electronic publications (e.g., books, periodicals, newspapers, etc.) using an electronic reader (e.g., an e-reader) or other user device (e.g., cellular telephones, personal digital assistants (PDAs), portable media players, tablet computers, netbooks, and the like). Users consume the electronic publication at different rates and in accordance with different reading habits. Accordingly, users navigate the flow of the content of the electronic publication and retain aspects of the publication in a variety of different ways.

### BRIEF DESCRIPTION OF DRAWINGS

The present disclosure will be understood more fully from the detailed description given below and from the accompanying drawings of various embodiments, which, however, should not be taken to limit the present disclosure to the specific embodiments, but are for explanation and understanding only.

FIG. 1 illustrates an example environment including an electronic publication reader device with an electronic publication navigation management system to manage a main publication navigational flow and a recaps navigational flow associated with an electronic publication, according to one or more embodiments.

FIG. 2 illustrates an example main publication navigational flow and an example recaps navigational flow including access points to enable navigation between the multiple navigational flows, according to one or more embodiments.

FIG. 3 illustrates an example interface of a device displaying a portion of a main publication navigational flow including multiple access points to a recaps navigational flow, according to one or more embodiments.

FIG. 4 illustrates example interfaces of a device displaying portions of a recaps navigational flow including multiple access points to a main publication navigational flow, according to one or more embodiments.

FIG. 5 depicts a flowchart illustrating example functionality implemented by an electronic publication navigation management system, according to one or more embodiments.

FIG. 6 illustrates an example navigation of a main publication navigational flow and a recaps navigational flow associated with an electronic publication, according to one or more embodiments.

FIG. 7 illustrates a diagrammatic representation of a machine in the example form of a computer system including a set of instructions executable by a computer to manage navigational flows associated with an electronic publication, according to one or more embodiments.

### DETAILED DESCRIPTION

The present disclosure relates to a method and system to manage multiple navigation structures or flows associated with an electronic publication generated for display via an interface of a user device (herein referred to as an e-reader). The electronic publication includes a first structure associated with first content of the electronic publication. The first content can include a primary or main portion of the electronic publication (herein referred to as the “main publication content” or “main publication”). For example, for an electronic book, the main publication content includes a set of pages or locations organized in a structure (e.g., a series of chapters).

The method and system manage and track the operations or actions taken by a user as the main publication content is navigated (also referred to as the “main publication navigational flow”). The main publication navigational flow can include a current location of the main publication content (e.g., a location within the main publication content identified by a location identifier), historical location information, one or more navigation actions executed via an interface of the e-reader (e.g., a forward navigation action (e.g., advancing to a next location), a backward navigation action (e.g., moving to a previous location within the main publication content, accessing a main navigation overview associated with the main publication content (e.g., a table of contents, a main menu, etc.).

The electronic publication further includes a second structure associated with second content of the electronic publication. The second content includes one or more recap or summary portions corresponding to one or more portions of the main publication content (herein referred to as the “recaps content”). For example, the second content can include a recaps content portion corresponding to each respective chapter of the main publication content, a set of multiple chapters, or the like. The recaps content can be organized in a structure that can be navigated by a user via actions indicated via an interface of the e-reader (herein the “recaps navigational flow”).

In an embodiment, the electronic publication further includes mapping information. The mapping information includes a mapping between the main publication content and the recaps content to enable a user to navigate between the main publication navigational flow and the recaps navigational flow. In an embodiment, the method and system use the mapping information to identify a destination location within either the main publication content or the recaps content in response to a navigational action by the user. In an embodiment, the mapping information (e.g., a mapping file) identify a correspondence between various locations of the main publication content and respective locations of the recaps content.

According to embodiments, the method and system can advantageously manage the main publication navigational flow (e.g., navigation actions to enable traversal of the main publication structure) and the recaps navigational flow (e.g., navigation actions to enable traversal of the recaps structure). In embodiments, the method and system enable a user to execute a variety of navigation actions relating to the main publication navigational flow and the recaps navigational flow (e.g., a page forward action, a page backward action, a chapter recap selection action, a selection of recap content corresponding to a current position within the main publication structure, etc.) Advantageously, locations and actions associated with the multiple different navigational flows are maintained and managed to enable a reader to dynamically navigate between the main publication content and recaps content in accordance with the mapping information.

As described above, the embodiments described herein overcome problems and challenges with respect to conventional electronic publication content by providing a separately navigable structure of recaps content supplementing the main publication content. The embodiments of the present application are directed to an electronic publication navigation management system configured to process indications associated with one or more access points providing navigation within and between portions of the main publication content and the recaps content in accordance with the mapping information. Advantageously, the electronic publication navigation management system according to the present application can be deployed in an electronic publication reader device to maintain information relating to the integration of the main publication navigational flow and the recaps navigational flow. In addition, the main publication content, recaps content, and mapping information can be provisioned to and stored on the electronic publication reader device as a self-contained, independent data object (e.g., electronic file) configured to enable user navigation of the main publication navigational flow, the recaps navigational flow, and between the navigational flows.

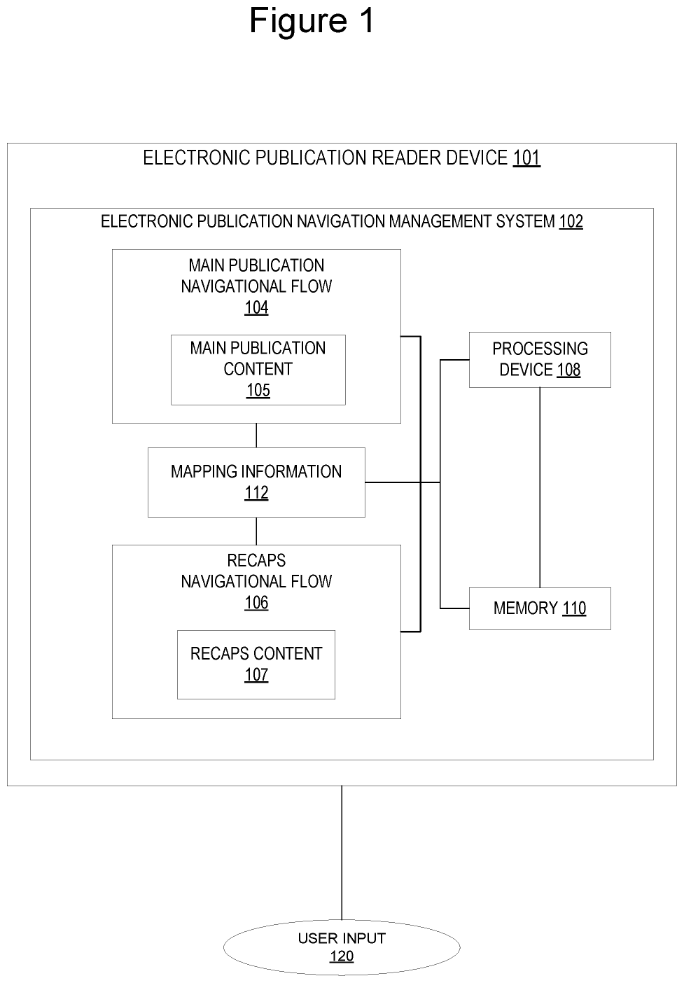

FIG. 1 illustrates an example electronic publication reader device 101 including an electronic publication navigation management system 102, according to embodiments of the present application. The electronic publication reader device 101 can an electronic reader device (e.g., an e-reader), a mobile device, a personal digital assistant (PDA), a portable media player, a tablet computer, a desktop computer, a laptop computer, a netbook, and the like configured to display an electronic publication including main publication content 105 and recaps content 107 via a graphical user interface (GUI). According to embodiments of the present invention, the electronic publication reader device 101 is configured to generate and display the electronic publication in any suitable format, such as, for example, an AEH format, a Broadband eBooks (BBeB) format, an eReader format, a HTML format (e.g., HTML5), an iBook format, a KF8 format, a CSS3 format, a Portable Document Format (PDF), or the like.

In an embodiment, the first navigational structure and the second navigational structure can be stored on the electronic publication reader device 101 (e.g., via a download operation) as an integrated file. In an embodiment, the integrated file can include the multiple navigational structures and corresponding mapping information to enable navigation between the multiple navigational structures via respective access points, as described in greater detail below.

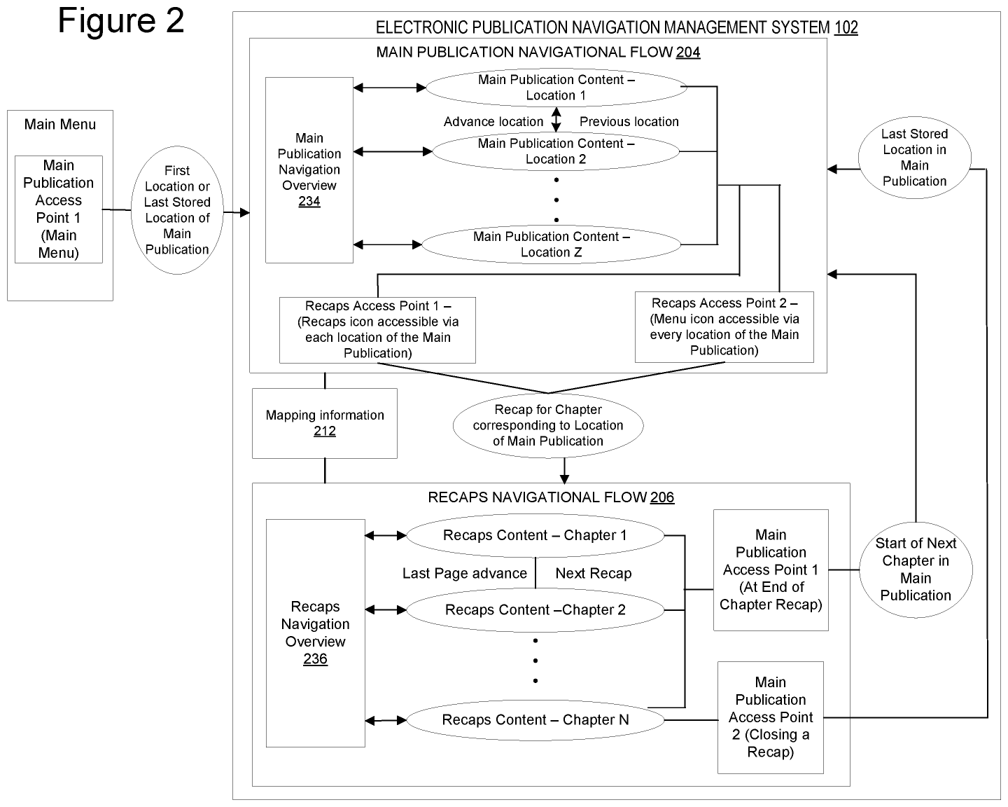

In an embodiment, the electronic publication navigation management system 102 manages user input 120 including commands associated with navigating the main publication navigational flow 104 and the recaps navigational flow 106. According to embodiments, as shown and described below in greater detail with reference to FIGS. 2-7, the electronic publication navigation management system 102 maintains the main publication navigational flow 104 (e.g., the navigation of the main publication content 105) and the recaps navigational flow 106 (e.g., the navigation of the recaps content) to allow the user to navigate within the main publication content, within the recaps content, and between the multiple navigational flows 104, 106.

In an embodiment, the electronic publication navigation management system 102 maintains and employs mapping information 112 to manage the navigation between the main publication navigational flow 104 and the recaps navigational flow 106. In an embodiment, the mapping information 112 includes a set of first locations of the main publication content 105 and a mapping or association identifying a corresponding set of second locations of the recaps content 107. In an example, the mapping information 112 can identify a correspondence between a first location of the main publication content 105 and a second location of the recaps content 107. In response to a navigation action by an end user (e.g., a reader) associated with the first location of the main publication content 105, the electronic publication navigation management system 102 accesses the mapping information 112, identifies the corresponding second location of the recaps content 107, and enables navigation to the second location of the recaps content 107.

In an embodiment, multiple different navigational flows can be maintained corresponding to the main publication content and the recaps content. For example, the main publication content can consist of multiple different structures associated with different versions of the main publication. In an embodiment, the electronic publication navigation management system 102 can further manage multiple different navigational flows corresponding to the multiple different versions of the main publication content.

In an embodiment, multiple different versions of the recaps content can also be maintained and managed by the electronic publication navigation management system 102. For example, the electronic publication navigation management system 102 can manage a first set of chapter-based recaps (e.g., a recap corresponding to each chapter of the main publication content) and a second set of image-based recaps (e.g., a recap that includes images, video, pictures, audio clips, etc.) associated with the main publication content.

In an embodiment, the electronic publication navigation management system 102 includes a processing device 108 and a memory 110. The memory 110 may be any suitable memory or data storage location, including a non-transitory computer readable storage medium, such as, but not limited to, any type of database, disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

FIG. 2 illustrates an example overview of the main publication navigational flow 204 and recaps navigational flow 206 as managed by the electronic publication navigation management system 102 of the present disclosure. As shown, the main publication navigational flow 204 includes a sequence of main publication locations (e.g., locations of the main publication content) each associated with a location identifier (e.g., Location 1, Location 2 . . . Location Z). The sequence of locations can be navigated by a user based on user input including commands such as an advance location command (e.g., page forward command such as a directional swipe or tap action) and a previous location command (e.g., page back command such as a directional swipe or tap action). The multiple locations of the main publication navigational flow 204 are associated with a main publication navigation overview 205. The main publication navigation overview 205 is an interactive representation (e.g., a table of contents) of the main publication content that enables the user to navigate to a selected location of the main publication content.

In an embodiment, the locations of the main publication navigational flow 204 are associated with one or more recaps access points. The recaps access points provide an interactive portion of the e-reader interface configured to access user input (e.g., an indication or action) that enables navigation from the main publication navigational flow 204 to the recaps navigational flow 206 in accordance with mapping information 212. In an embodiment, the mapping information 212 is used to identify a destination location of the main publication navigational flow 204 or the recaps navigational flow 206 in response to a navigational action by the user indicating navigation between the main publication navigational flow 204 and the recaps navigational flow 206.

In an embodiment, the main publication navigational flow 204 can include a first recaps access point (e.g., Recaps Access Point 1) providing an interactive portion (e.g., an icon, link, etc.) that enables navigation from a current location within the main publication (e.g., location 1 in chapter 1) to a corresponding portion of the recap content. In the example shown in FIG. 2, the recaps navigational flow 206 is configured in a chapter-based structure, where each portion or segment of the recaps portion corresponds to a chapter of the main publication content (e.g., Chapter 1 Recap, Chapter 2 Recap . . . Chapter N Recap for a main publication including N chapters). In an embodiment, the interface of the e-reader includes a first recaps access point corresponding to each location of the main publication. In an embodiment, in response to a selection of the first recaps access point, the electronic publication navigation management system 102 identifies a current location of the main publication and determines the corresponding portion of the recaps content.

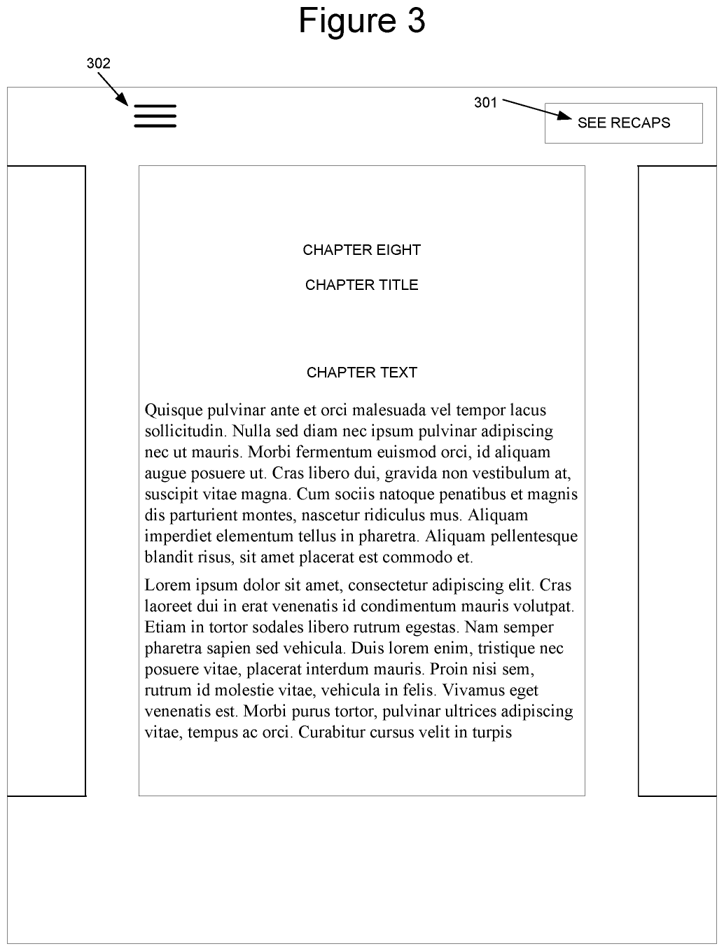

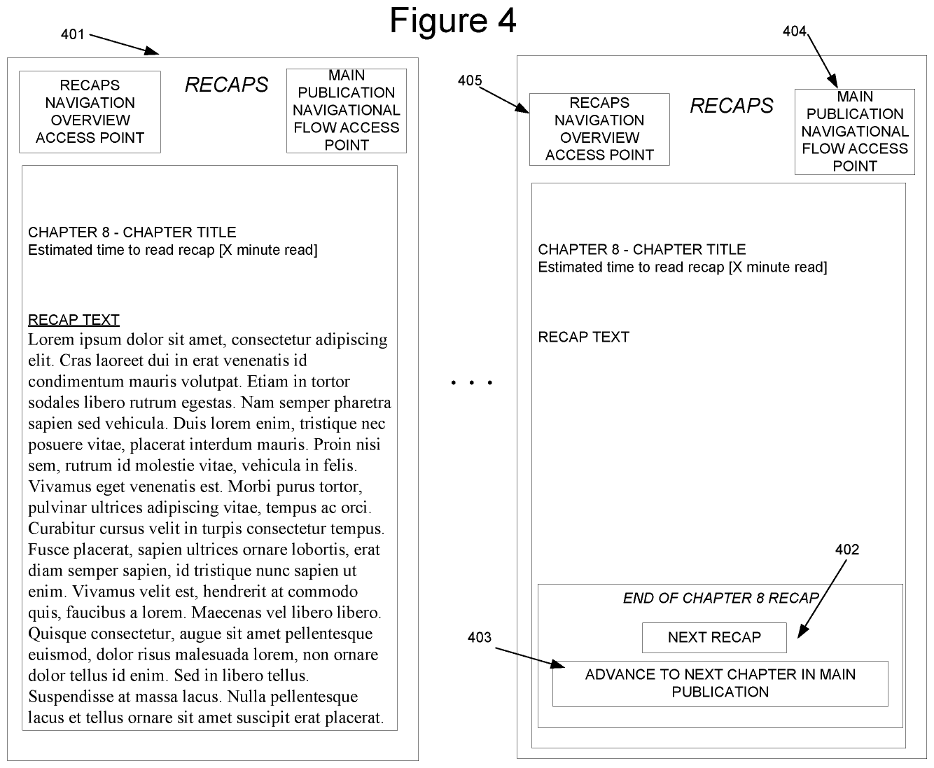

FIG. 3 illustrates an example interface including a location of main publication content associated with Chapter 8. As shown in FIG. 3, the portion of the interface labeled “See Recaps” 301 represents a recaps access point. In this example, since the current location of the main publication is within Chapter 8, the electronic publication navigation management system 102 enables navigation to the Chapter 8 Recap of the recaps content 401, as shown in FIG. 4.

As shown in FIG. 2, the main publication navigational flow 204 can include a further recaps access point (e.g., Recaps Access Point 2) to enable navigation from the main publication navigational flow 204 to the recaps navigational flow 206. For example, the recaps access point can include a portion of the interface associated with a main menu (e.g., the menu line stack in FIG. 3) which is accessible via each location of the main publication. In an embodiment, selection of Recaps Access Point 2 can correspond to a main menu including a “recaps” option that results in navigation to a corresponding portion of the recaps navigational flow 206. In the example shown in FIGS. 3 and 4, selection of the main menu icon 302 from a location of the main publication within Chapter 8 results in the provisioning of a “recaps” option (not shown) which, if selected, navigates to an initial or starting location of the Chapter 8 Recap 401 (as shown in FIG. 4).

As shown in FIG. 2, a user indication or selection associated with a recaps access point (e.g., Recaps Access Point 1 or Recaps Access Point 2) results in the navigation to a recap within the recaps navigational flow that is associated in the mapping information 212 with the current location of the main publication. In an embodiment, upon navigation from the main publication navigational flow 204 to the recaps navigational flow 206, the electronic publication navigation management system 102 identifies and stores a last or previous location of the main publication (e.g., a current location of the main publication that corresponds to the ingress into the recaps navigational flow 206) and identifies a corresponding location of the recaps navigational flow 206 based on the mapping information 212. In an embodiment, the last or previous location of the main publication can be stored as part of the mapping information 212.

As shown in FIG. 2, the recaps navigational flow 206 is managed and maintained by the electronic publication navigation management system 102. The recaps navigational flow 206 can include the navigation of various locations within the recaps content. For example, for a chapter-based recap structure, the recaps navigational flow 206 includes the navigation through the locations within a chapter recap (e.g., a chapter recap may include X number of pages having Z number of locations) that are navigated through via various user actions or interactions with the interface.

In an embodiment, the recaps navigational flow 206 can include progressing from a first recap (e.g., recap of Chapter 1) to a second recap (e.g., recap of Chapter 2). This progression can be executed by advancing from a last page of the first recap or by the selection of a “next recap” icon or access point. In an embodiment, a user can navigate to a selected recap location (e.g., a recap associated with Chapter N) by selecting a corresponding location via the recaps navigation overview 236. In an embodiment, the recaps navigation overview 236 includes a listing of multiple portions of the recaps content (e.g., a table of contents) that represent an access point to each respective recaps portion. According, a user can navigate through the recaps content using the recaps navigation overview and actions (e.g., page forward, page backward, a “Next Recap” link 402 of FIG. 4, etc.) within the recaps navigational flow 206.

In an embodiment, the recaps navigational flow 206 includes one or more access points that are mapped to a location of the main publication navigational flow 204 in the mapping information 212. In an embodiment, the recaps navigational flow 206 includes a first main publication access point (e.g., Main Publication Access Point 1). In an embodiment, the first main publication access point can be located at the end of each chapter-based recap. For example, as shown in FIG. 4, at the end of the Chapter 8 recap, an interactive access point labeled “Advance to Next Chapter in Main Publication” is presented via the interface. In this example, selection of the “Advance to Next Chapter in Main Publication” navigates to a starting location of Chapter 9 of the main publication.

In an embodiment, the recaps navigational flow 206 includes a second main publication access point (e.g., Main Publication Access Point 2). In an embodiment, the second main publication access point is presented in connection with each location of the recaps content. For example, the second main publication access point represents a closing of the current recap (e.g., an “X” or other icon representing a closing action with respect to the current recap location.

As illustrated in FIG. 2, interaction with Main Publication Access Point 2 navigates to a last stored location in the main publication. In an embodiment, the mapping information 212 can be updated to include the last stored location in the main publication content for use in a subsequent mapping in response to a navigation via the Main Publication Access Point 2. For example, a user may navigate from chapter 7 of the main publication content to the chapter 7 recap in the recaps navigational flow 206. The user may advance through the chapter 7 recap to the chapter 10 recap. In this example, interaction with the main publication access point 2 associated with a location of the chapter 10 recap results in the navigation to chapter 7 of the main publication since that is the last stored location in the main publication.

As shown in FIG. 4, the recaps portions (e.g., recap portion 401) can include an access point associated with the recaps navigation overview 405. In an embodiment, interaction with the recaps navigation overview access point 405 navigates the user to the recaps navigation overview (e.g., table of contents listing each of the accessible recap portions).

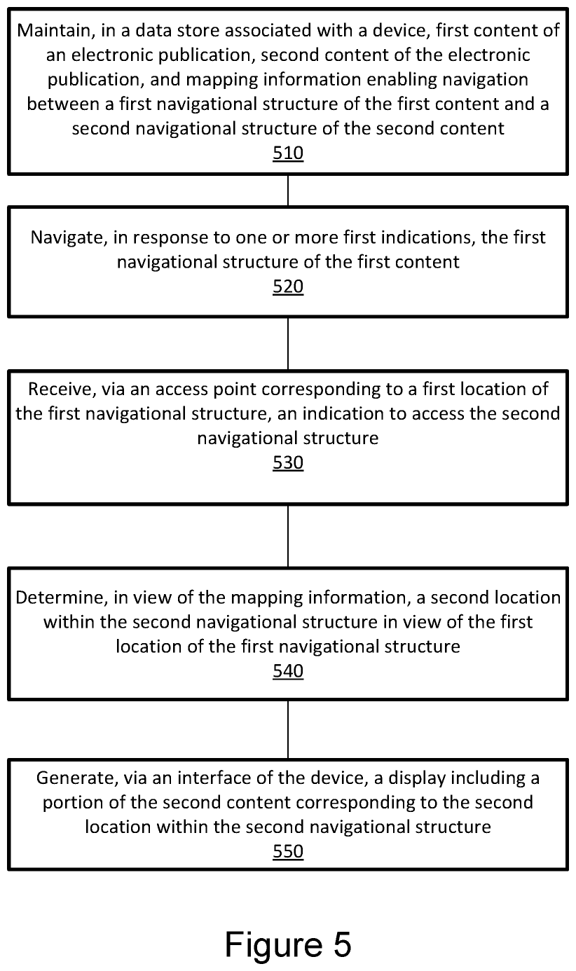

FIG. 5 is an exemplary flow diagram of one embodiment of a method 500 for managing a main publication navigational flow and recaps navigational flow associated with an electronic publication, according to embodiments of the present disclosure. It is understood that the flowchart of FIG. 5 provides an example of the many different types of functional arrangements that may be employed to implement the operation of the electronic publication navigation management system as described herein. The method 500 of FIG. 5 may be performed by processing logic of the electronic publication navigation management system (e.g., of a drive unit) that comprises hardware (e.g., circuitry, dedicated logic, programmable logic, microcode, etc.), software (e.g., instructions run on a processing device to perform hardware simulation), or a combination thereof. The operations of method 500 may be performed in any order so as to fit the needs of the functionality to be provided.

In block 510, processing logic maintains, in a data store associated with a device, first content of an electronic publication, second content of the electronic publication, and mapping information enabling navigation between a first navigational structure of the first content and a second navigational structure of the second content. In an embodiment, the first content is the main publication content (e.g., the primary content of an electronic book, magazine, periodical, article, etc.). In an embodiment, the first navigational structure includes an ordered set of locations of the first content (e.g., location 1 through location X of the main publication). In an embodiment, the second content includes a set of recaps portions corresponding to portions of the first content. The second navigational structure includes an ordered set of recaps corresponding to portions of the first content. For example, the second navigational structure can include a set of multiple chapter-based recaps, where a recap is maintained for each chapter of the main publication. In an embodiment, the processing logic maintains, in the data store, the mapping information including mappings between respective locations of the first navigational structure and the second navigational structure to enable navigation therebetween. In an embodiment, the data store can be locally stored on the device (e.g., an e-reader or other user device) or maintained remotely via a network. In an embodiment, the first navigational structure and the second navigational structure can be provisioned, downloaded, or otherwise provided to the device (e.g., the e-reader) as an integrated or single file. In an embodiment, the file can include the multiple navigational structures and the mapping information to enable navigation between the multiple navigational structures via respective access points.

In block 520, processing logic navigates, in response to one or more first indications, the first navigational structure of the first content. In an embodiment, the first indications can include one or more actions, operations, or interactions (e.g., user input) executed via an interface of the device that relate to the navigation of the first content. In an embodiment, the one or more first indications can result in the navigation of the set of locations of the first navigational structure.

In block 530, the processing logic receives, via an access point corresponding to a first location of the first navigational structure, an indication to access the second navigational structure. In an embodiment, the indication (e.g., a click, voice command, etc.) associated with the access point is received in connection with the first location of the first navigational structure (e.g., a location within a portion of the main publication). In an embodiment, the access point can be an interactive portion of the interface providing access to the second content (e.g., a recap) presented in connection with the current location of the main book. In an embodiment, the processing logic stores the last location of the first navigational structure in response to the indication associated with navigation to the second navigational structure.

In block 540, the processing logic determines, in view of the mapping information, a second location within the second navigational structure in view of the first location of the first navigational structure. In an embodiment, the processing logic maintains the mapping information indicating a location within the second navigational structure that corresponds to each location of the first navigational structure. For example, the processing logic uses the mapping information to determine the current location (e.g., first location) is a location within Chapter X of the main publication. In an embodiment, the processing logic determines the second location is an initial or start point of a recap corresponding to Chapter X.

In block 550, the processing logic generates, via an interface of the device, a display including a portion of the second content corresponding to the second location within the second navigational structure. In an embodiment, the portion of the second content can include a recap associated with the last location of the main publication. In an embodiment, the user can navigate a set of locations within the second navigational structure in response to one or more indications or user input.

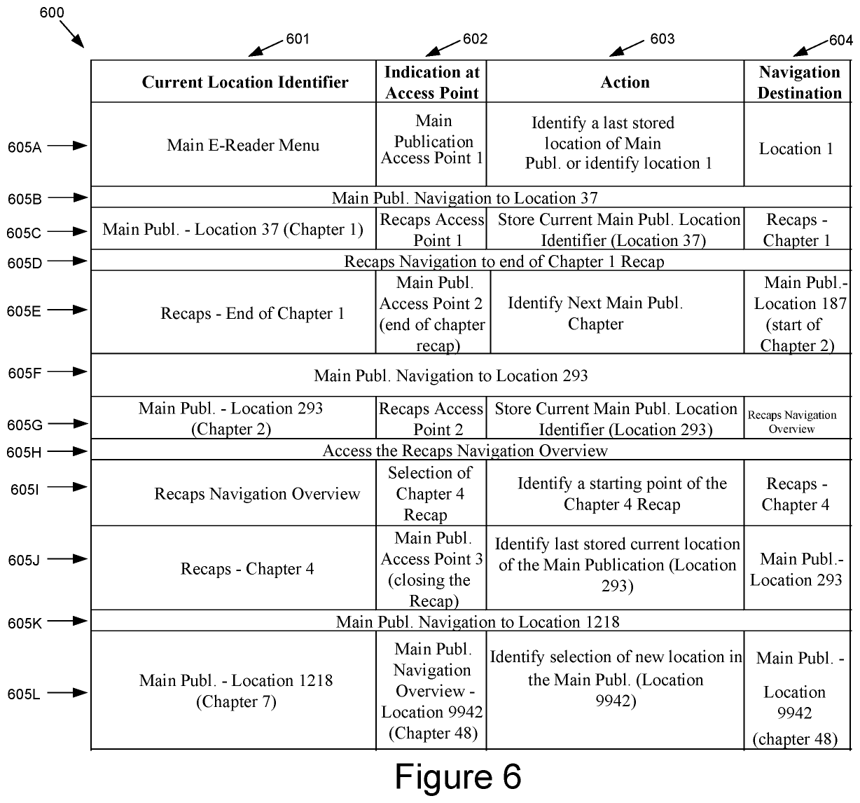

In an embodiment, the method 500 can include further navigation between the first navigational structure and the second navigational structure based on input signals received from the user and the mapping information. An example of navigation between the navigational structures is described in connection with FIG. 6.

FIG. 6 illustrates an example data structure 600 (e.g., a table) storing information related to management by an electronic publication management system of a main publication navigational flow and a recaps navigational flow associated with an electronic publication generated and displayed via an interface of an electronic device (e.g., an e-reader). The data structure 600 includes columns of information 601-604 tracked and managed by the electronic publication management system (e.g., electronic publication management system 102 of FIG. 1). In the example shown, the data structure 600 includes a current location identifier column 601, an indication at access point column 602, an action column 603, and a navigation destination column 604.

In an embodiment, the current location identifier column 601 includes information identifying a current location of the electronic publication that is displayed by the e-reader. In an embodiment, the indication at access point column 602 includes information identifying an access point that has received an indication (e.g., an interaction by a user via the interface). In an embodiment, the action column 603 includes information identifying one or more actions performed by the electronic publication management system in response to an indication at an access point. In an embodiment, the navigation destination column 604 includes information identifying a destination of a navigation action performed by the electronic publication management system in response to user input. In some instances, the destination is identified based on the mapping information when the navigation action indicates a navigation between the navigational flows.

In an embodiment, the data structure 600 includes information identifying one or more actions (e.g., user actions indicated and requested by input from a user via the interface and navigation actions) 605A-605L. The actions 605A-605L include activities, indications, and navigational processing that result in a navigation of one or more of the main publication navigational flow and the recaps navigational flow.

In the example shown in FIG. 6, at action 605A, the e-reader presents a main e-reader menu via the interface and receives an indication at an access point to the main publication (e.g., main publication access point 1). In response, the electronic publication navigation management system identifies a last stored location of the main publication (e.g., if the user has previously interacted with the electronic publication and has an associated “last location” within the main publication or identifies location 1 (e.g., a starting point or first location of the main publication if the user has not previously consumed the main publication). In the example shown, the user has not previously interacted with the main publication so the navigation destination is identified as Location 1 of the main publication.

At action 605B, the user navigates from Location 1 of the main publication to Location 37 via one or more navigational actions (e.g., swipes, taps, etc.). In this example, Location 37 is part of Chapter 1 of the main publication.

At action 605C, the user provides an indication at a recaps access point 1 provided via the interface in connection with the current location of the main publication (e.g., Location 37 within Chapter 1). In response to the indication at the recaps access point, the electronic publication navigation management system stores the current location of the main publication (e.g., Location 37) and uses the mapping information to identify a corresponding navigation destination within the recaps navigational flow. In this example, since Location 37 of the main publication is in Chapter 1, the mapping information indicates that the navigation destination is the Chapter 1 Recap portion.

At action 605D, the user navigates within the recaps navigational flow from a starting point of the Chapter 1 Recap portion to an end point or last page of the Chapter 1 Recap portion via one or more navigational actions.

At action 605E, the user provides an indication at a main publication access point (e.g., main publication access point 403 of FIG. 4) provided via the interface in connection with the current location of the recaps (e.g., the end of the Chapter 1 Recap). In response to the indication at the main publication access point, the electronic publication navigation management system uses the mapping information to identify a next chapter in the main publication relative to the current location of the recaps. In this example, the navigation destination is identified as a starting point of Chapter 2 of the main publication (e.g., location 187 of the main publication).

At action 605F, the user navigates within the main publication navigational flow from a starting point of the Chapter 2 (e.g., location 187) to location 293.

At action 605G, the user provides an indication at a recaps access point (e.g., recaps navigation overview 236 of FIG. 2 or recaps navigation overview 405 of FIG. 4) provided via the interface in connection with the current location of the main publication (e.g., location 293). In response to the indication at the recaps access point, the electronic publication navigation management system stores a current location of the main publication (e.g., location 293) and uses the mapping information to identify the recaps navigation overview (e.g., a table of contents associated with the recaps navigational flow) as the navigation destination.

At action 605H, the user is provided with access to the recaps navigation overview listing each portion of the available recaps as a selectable navigation point. At action 605I, the user provides an indication or selection of a Chapter 4 recap. In response, the electronic publication navigation management system identifies a starting point of the Chapter 4 recap portion within the recaps navigational flow and establishes the Chapter 4 recap as the navigation destination.

At action 605J, the user provides an indication at a main publication access point (e.g., main publication navigational flow access point 404 of FIG. 4) provided via the interface in connection with the current location of the recap navigational flow (e.g., a location within the Chapter 4 recap). In response to the indication at the main publication access point, the electronic publication navigation management system uses the mapping information to identify the previously stored current location of the main publication navigational flow (e.g., location 293 of Chapter 2) and identifies location 293 of the main publication navigational flow as the navigation destination.

At action 605K, the user navigates within the main publication navigational flow from location 293 (Chapter 2 of the main publication) to location 1218 (Chapter 7 of the main publication). At action 605L, the user provides an indication at a main publication navigation overview access point (e.g., main publication navigation overview 234 of FIG. 2). In an embodiment, the main publication navigation overview (e.g., a table of contents) provides a listing of locations of the main publication that can be selected by the user for direct navigation to the selected location. In this example, the user provides an indication via the main publication navigation overview of a selection of location 9942 in Chapter 48 of the main publication. In response to the selection, the electronic publication navigation management system identifies the selected location of the main publication and navigates to the selected location (e.g., location 9942 of Chapter 48) of the main publication navigation flow.

As illustrated by the example shown in FIG. 6 and described above, the electronic publication navigation management system maintains information associated with the multiple navigation flows (e.g., the main publication navigation flow and the recaps navigation flow) to enable a user to navigate within the respective navigation flows and access another navigation flow via one or more access points.

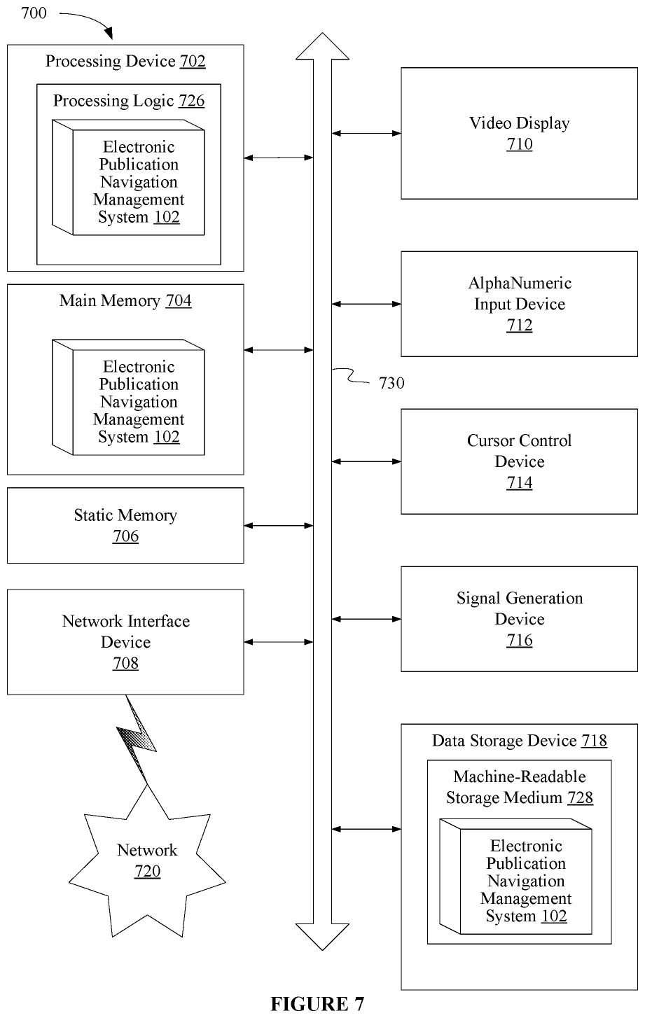

FIG. 7 illustrates a diagrammatic representation of a machine in the example form of a computer system 700 including a set of instructions executable by a computer to manage multiple navigational flows associated with an electronic publication according to any one or more of the methodologies discussed herein. In one embodiment, the computer may include instructions to enable execution of the processes and corresponding components shown and described in connection with FIGS. 1-6.

In alternative embodiments, the machine may be connected (e.g., networked) to other machines in a LAN, an intranet, an extranet, or the Internet. The machine may operate in the capacity of a server machine in a client-server network environment. The machine may be a personal computer (PC), a set-top box (STB), a server, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein

The example computer system 700 includes a processing device (processor) 1202, a main memory 704 (e.g., read-only memory (ROM), flash memory, dynamic random access memory (DRAM) such as synchronous DRAM (SDRAM)), a static memory 706 (e.g., flash memory, static random access memory (SRAM)), and a data storage device 718, which communicate with each other via a bus 730.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like. In various implementations of the present disclosure, the processing device 702 is configured to execute instructions for the electronic publication navigation management system 102 for performing the operations and processes described herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a computer-readable storage medium 728 (or machine-readable medium) on which is stored one or more sets of instructions of the electronic publication navigation management system 102 embodying any one or more of the methodologies or functions described herein. The instructions may also reside, completely or at least partially, within the main memory 704 and/or within processing logic 726 of the processing device 702 during execution thereof by the computer system 700, the main memory 704 and the processing device 702 also constituting computer-readable media.

The instructions may further be transmitted or received over a network 720 via the network interface device 708. While the computer-readable storage medium 728 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely presented as examples. Particular implementations may vary from these example details and still be contemplated to be within the scope of the present disclosure. In the above description, numerous details are set forth.

It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to the desired result. The steps are those requiring physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as: detecting”, “identifying”, “determining”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present disclosure as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
maintaining, in a data store associated with a device, first content of an electronic publication, second content of the electronic publication, and mapping information enabling navigation between a first navigational structure of the first content and a second navigational structure of the second content;
navigating, in response to one or more first indications, the first navigational structure of the first content;
receiving, via an access point corresponding to a first location of the first navigational structure, an indication to access the second navigational structure;
storing, in response to the indication to access the second navigational structure, information identifying the first location of the first navigational structure;
determining in view of the mapping information, by a processing device of the device, a second location within the second navigational structure in view of the first location of the first navigational structure; and
causing, via an interface of the device, a display of a portion of the second content corresponding to the second location within the second navigational structure.

2. The method of claim 1, wherein the first content comprises a main publication and the second content comprises a set of recap portions corresponding to the main publication.

3. The method of claim 2, wherein the first navigational structure comprises a first set of locations of a main publication and one or more recaps access points to the set of recaps portions of the second navigational structure.

4. The method of claim 3, wherein the second navigational structure comprises the set of recaps portions and one or more main publication access points to the set of locations of the first navigational structure.

5. (canceled)

6. The method of claim 6, further comprising navigating, in view of the mapping information, from the second navigational structure to the first location of the first navigational structure in response to a further indication associated with a main publication access point corresponding to the first navigational structure.

7. The method of claim 1, wherein the first navigational structure comprises a main publication navigation overview including a first listing of a first set of locations of the first navigational structure; and wherein the second navigational structure comprises a recaps navigation overview including a second listing of a second set of locations of the second navigational structure.

8. The method of claim 7, further comprising:
receiving, via the main publication navigation overview, a selection of a second location of the first set of locations of the first navigational structure; and
displaying, via the interface, a portion of the first content of the first navigational structure corresponding to the second location of the first set of locations of the first navigational structure.

9. The method claim 8, further comprising:
receiving, via the recaps navigation overview, a further selection of a second location of the second set of locations of the second navigational structure; and
displaying, via the interface, a second portion of the second content of the second navigational structure corresponding to the second location of the second set of locations of the second navigational structure.

10. A system comprising:
a processing device; and
a memory to store computer-executable instructions that, if executed, cause the processing device to:
store a first navigational structure associated with main publication content of an electronic publication, wherein the first navigational structure comprises a set of locations organized in a set of chapters of the main publication;
store a second navigational structure associated with recaps content of the electronic publication, wherein the second navigational structure comprises a set of chapter-based recap portions corresponding to the set of chapters of the main publication;
store mapping information identifying a correspondence between the set of locations organized in the set of chapters of the main publication and the set of chapter-based recap portions;
generate a first display comprising a first location of the set of locations of the main publication, wherein the first location corresponds to a first chapter of the main publication;
receive a first indication from a user corresponding to a first recaps access point to the second navigational structure;
store, in response to the first indication, information identifying a current location of the first navigational structure associated with the first recaps access point identify, in view of the mapping information, a first chapter-based recap portion corresponding to the first chapter of the main publication content; and
cause a second display comprising the first chapter-based recap portion corresponding to the first chapter of the main publication content.

11. The system of claim 10, the processing device further to receive one or more navigation actions from a user to navigate from a starting point of the first chapter-based recap portion to an ending point of the first chapter-based recap portion comprising a first main publication access point.

12. The system of claim 11, the processing device further to:
receive a second indication from the user corresponding to the first main publication access point; and
generate a third display comprising of a second location of the main publication identified in view of the mapping information, wherein the second location corresponds to a second chapter of the main publication.

13. The system of claim 10, the processing device further to:
generate a main publication overview access point providing access to a first listing of the set of locations of the main publication; and
generate a recaps overview access point providing access to a second listing of the set of chapter-based recap portions.

14. A non-transitory computer-readable storage device storing computer-executable instructions that, if executed by a processing device, cause the processing device to:
maintain, in a data store associated with a device, first content of an electronic publication, second content of the electronic publication, and mapping information enabling navigation between a first navigational structure of the first content and a second navigational structure of the second content;
navigate, in response to one or more first indications, the first navigational structure of the first content;
receive, via an access point corresponding to a first location of the first navigational structure, an indication to access the second navigational structure;
store, in response to the indication to access the second navigational structure, information identifying the first location of the first navigational structure;
determine, in view of the mapping information, a second location within the second navigational structure in view of the first location of the first navigational structure; and
generate, via an interface of the device, a display comprising a portion of the second content corresponding to the second location within the second navigational structure.

15. The non-transitory computer-readable storage device of claim 14, wherein the first content comprises a main publication and the second content comprises a set of recap portions corresponding to the main publication.

16. The non-transitory computer-readable storage device of claim 15, wherein the first navigational structure comprises a first set of locations of a main publication and one or more recaps access points to the set of recaps portions of the second navigational structure.

17. The non-transitory computer-readable storage device of claim 16, wherein the second navigational structure comprises the set of recaps portions and one or more main publication access points to the set of locations of the first navigational structure.

18. (canceled)

19. The non-transitory computer-readable storage device of claim 14, the processing device further to navigate, in view of the mapping information, from the second navigational structure to the first location of the first navigational structure in response to a further indication associated with a main publication access point corresponding to the first navigational structure.

20. The non-transitory computer-readable storage device of claim 14, wherein the first navigational structure comprises a main publication navigation overview including a first listing of a first set of locations of the first navigational structure; and wherein the second navigational structure comprises a recaps navigation overview including a second listing of a second set of locations of the second navigational structure, the processing device further to:
receive, via the main publication navigation overview, a selection of a second location of the first set of locations of the first navigational structure;
generate, via the interface, a third display comprising a portion of the first content of the first navigational structure corresponding to the second location;
receive, via the recaps navigation overview, a further selection of a second location of the second set of locations of the second navigational structure; and
generate, via the interface, a fourth display comprising a second portion of the second content of the second navigational structure corresponding to the second location.
